(19) United States
(12) Patent Application Publication
(10) Pub. No.: US 2015/0332658 A1
(43) Pub. Date: Nov. 19, 2015

(54) COMPUTER APPARATUS AND CONTROL METHOD THEREOF

(71) Applicant: Kabushiki Kaisha Toshiba, Tokyo (JP)

(72) Inventors: Kazuhiro Nakamura, Hachioji Tokyo (JP); Hiroshi Aiba, Ome Tokyo (JP)

(21) Appl. No.: 14/585,530

(22) Filed: Dec. 30, 2014

Related U.S. Application Data
(60) Provisional application No. 61/993,583, filed on May 15, 2014.

(51) Int. Cl. G09G 5/377; G06F 1/16

(52) U.S. Cl. CPC G09G 5/377; G06F 1/1632; G09G 2340/12

(57) ABSTRACT

According to one embodiment, in a computer apparatus connecting a display dock including a display device and an operation dock whose back surface is a placement surface, an imaging device configured to capture an image in accordance with an imaging instruction input is provided on the back surface of the operation dock, and when the computer apparatus is placed, an image of a set place is captured by the imaging device in accordance with a display instruction input and is displayed in the display device of the display dock.

### CROSS-REFERENCE TO RELATED APPLICATIONS

This application claims the benefit of U.S. Provisional Application No. 61/993,583, filed May 15, 2014, the entire contents of which are incorporated herein by reference.

### FIELD

Embodiments described herein relate generally to, for example, a clamshell or convertible computer apparatus, and for example, a control method for connection to a docking station.

### BACKGROUND

In a clamshell computer or a convertible tablet computer (hereinafter, referred to as a computer), a docking station for feature expansion is used at the desk of the user or in the destination of movement in order to easily ensure a power source in the use place and easily realize connection to a communication system.

A conventional docking station is prepared as an option for a computer. The docking station comprises a physical guide according to the shape of the corresponding computer. By merely placing the computer in line with the guide, it is possible to easily realize docking of their connectors.

However, the conventional docking station lacks versatility. Therefore, for example, in order to use a variety of computers in a conference room, docking stations corresponding to all of the computers should be prepared.

In consideration of the above factors, there is a demand for common use of a docking station by various types of computer. To realize this use, easy connection to the docking station is required even if a physical guide is not provided on the computer side. Thus, the docking station requires versatility.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1A and FIG. 1B are perspective illustrations each showing a structure of a clamshell computer according to a first embodiment.

FIG. 2A and FIG. 2B are a perspective illustration showing a structure of a conventional docking station having an expansion function of the computer shown in FIG. 1 and a perspective illustration showing a structure of a docking station in the first embodiment respectively.

FIG. 3 is a block diagram showing an outline structure of the computer shown in FIG. 1.

FIG. 4A and FIG. 4B are perspective illustrations each showing a state in which the computer shown in FIG. 1A and FIG. 1B docks with the docking station shown in FIG. 2B.

FIG. 5 is a flowchart showing a processing program executed by the computer when the docking shown in FIG. 4A and FIG. 4B is executed.

FIG. 6 is a perspective illustration showing a first example for activating the processing program of the docking shown in FIG. 5.

FIG. 7 is a perspective illustration showing a second example for activating the processing program of the docking shown in FIG. 5.

FIG. 8 is a perspective illustration showing a third example for activating the processing program of the docking shown in FIG. 5.

FIG. 9 is a perspective illustration showing a structure of a convertible tablet computer according to the first embodiment.

FIG. 10A, FIG. 10B, FIG. 100 and FIG. 10D are perspective illustrations each for explaining a transfer detection security function provided in a computer according to a second embodiment.

FIG. 11 is a flowchart showing processing steps of the transfer detection security system.

### DETAILED DESCRIPTION

Various embodiments will be described hereinafter with reference to the accompanying drawings.

In general, according to one embodiment of the invention, a computer connecting a display dock comprising a display device and an operation dock whose back surface is a placement surface comprises:

an imaging device provided on the back surface of the operation dock, the imaging device being configured to capture an image in accordance with an imaging instruction input; and

a display control unit configured to display the image captured by the imaging device in the display device of the display dock in accordance with a display instruction input.

### First Embodiment

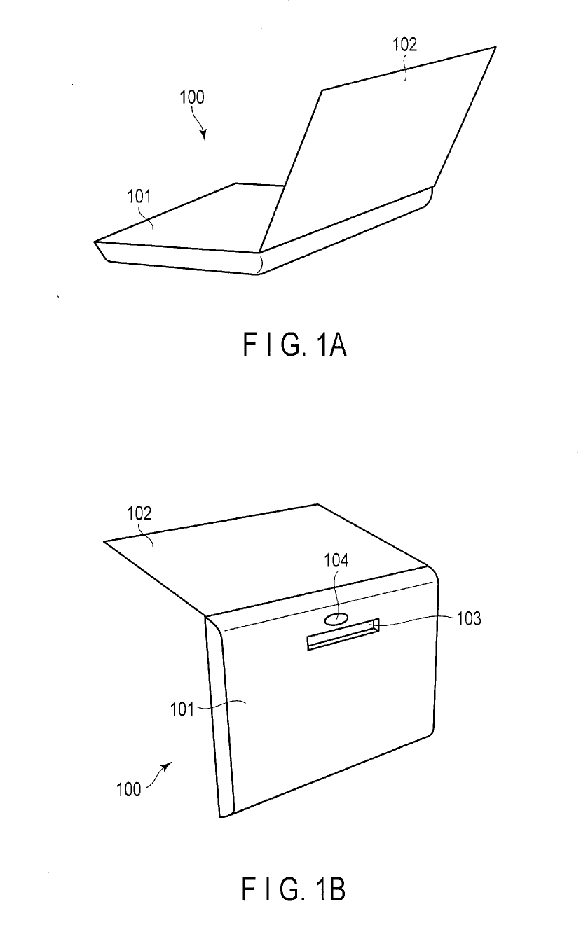

FIG. 1A and FIG. 1B are perspective illustrations each showing a structure of a clamshell personal computer 100 according to a first embodiment. FIG. 1A is a perspective illustration showing the external appearance of the computer 100. FIG. 1B is a perspective illustration showing the bottom surface of the computer 100.

The computer 100 is a clamshell type in which an operation dock 101 comprising a keyboard and a pad, etc., is integrated with a display dock 102 comprising a display panel by means of a hinge mechanism in such a way that the docks are freely opened and closed. In this model, a connector 103 for external connection is provided on the bottom surface which is the placement surface. The connector 103 is used for connection to a docking station. In this embodiment, a video camera 104 for imaging a surface facing the connector 103 is provided near the connector 103.

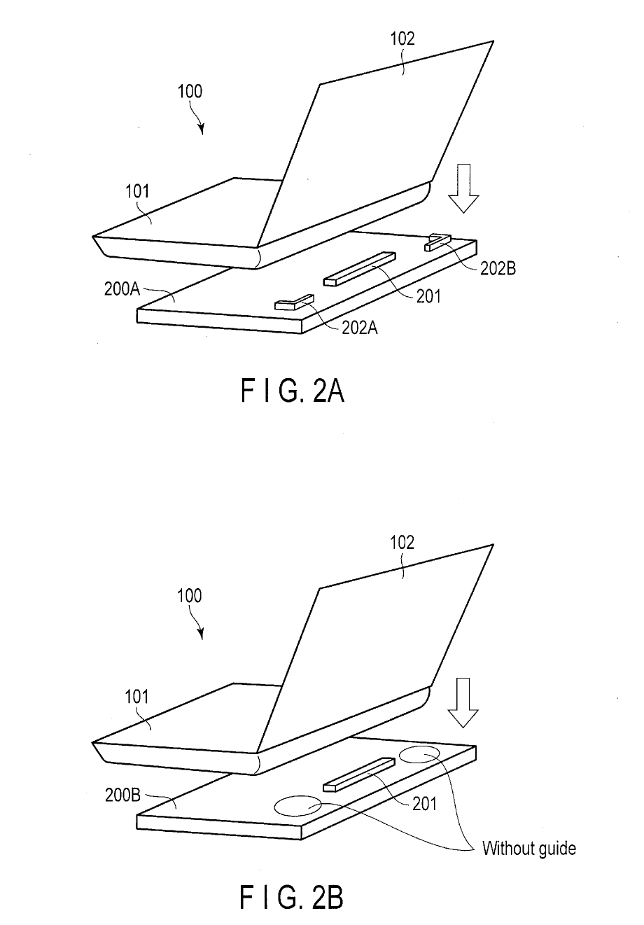

FIG. 2A and FIG. 2B are a perspective illustration showing a structure of a conventional docking station having an expansion function of the computer shown in FIG. 1A and FIG. 1B, and a perspective illustration showing a structure of a docking station in the first embodiment respectively. As shown in FIG. 2A, conventional docking station 200A comprises a docking connector 201 for connection to the computer 100, and physical guides 202a and 202b for guiding the computer 100 to the connection position of the connector. In contrast, as shown in FIG. 2B, although docking station 200B of the embodiment comprises the docking connector 201 on the placement surface for the computer 100, docking station 200B does not comprise a physical guide for position determination in such a way that the docking station can be versatile.

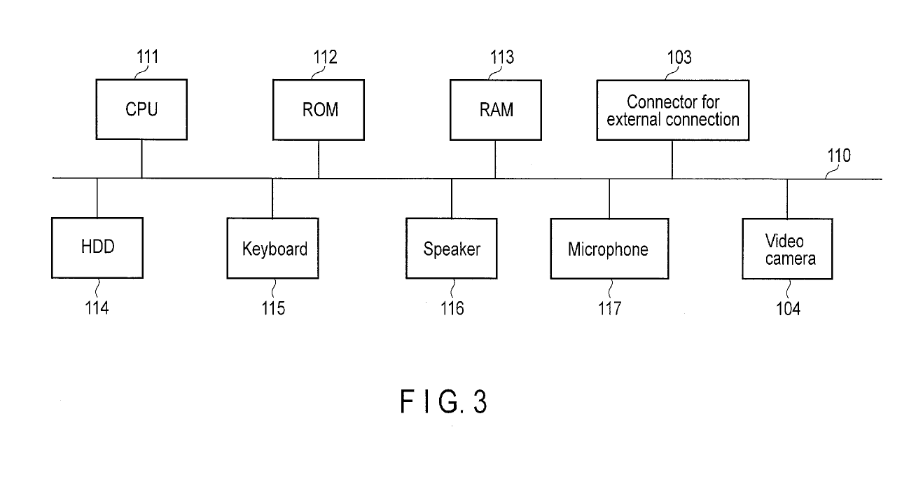

FIG. 3 is a block diagram showing an outline structure of the computer 100. The computer 100 comprises a bus 110 to which a central processing unit (CPU) 111, a read-only memory (ROM) 112 for program recording, a random access memory (RAM) 113 for a data processing work, a hard disk device (HDD) 114 for data recording, a keyboard 115, a speaker 116 and a microphone 117, etc., are connected. Further, the connector 103 for external connection and the video camera 104 are connected to the bus 110.

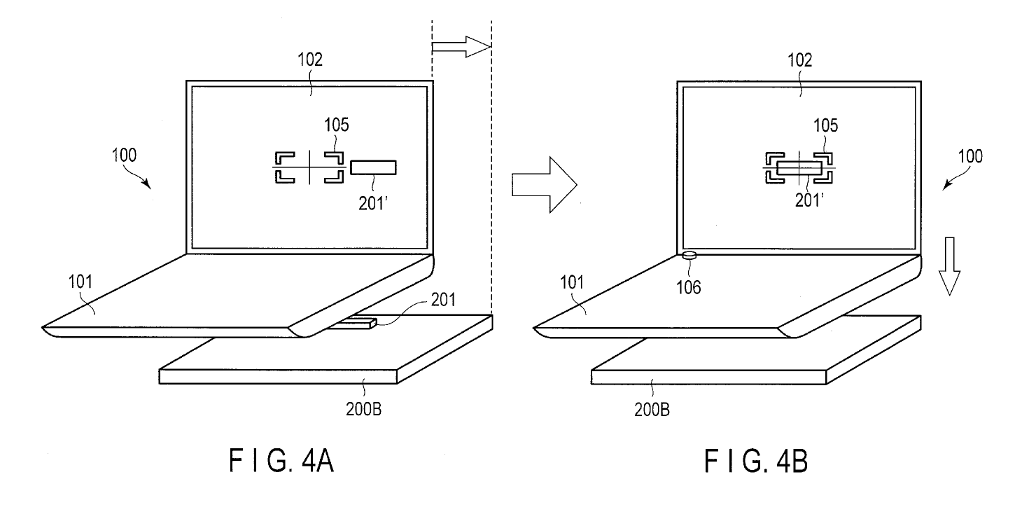

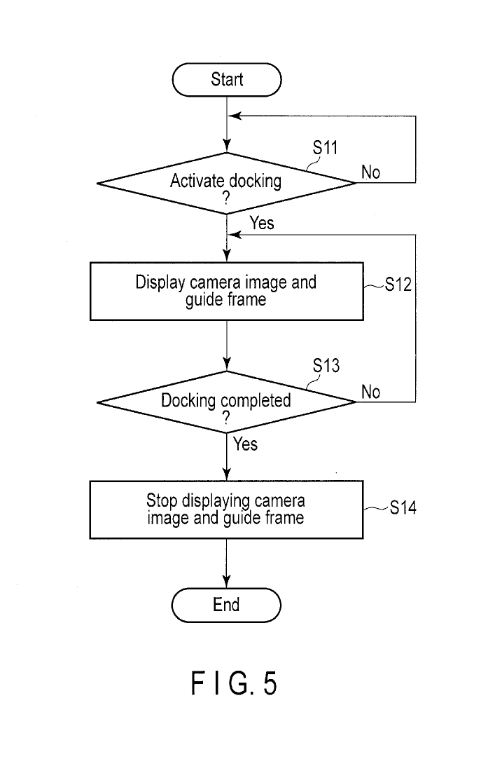

With reference to FIG. 4A, FIG. 4B and FIG. 5, this specification explains the flow of a process of connector connection to docking station 200B by a video signal produced by means of the video camera 104 in the computer 100 having the above structure.

FIG. 4A and FIG. 4B are perspective illustrations each showing a state in which the computer shown in FIG. 1A and FIG. 1B docks with the docking station shown in FIG. 2B. FIG. 5 is a flowchart showing a processing program executed by the computer when the docking shown in FIG. 4A and FIG. 4B is executed.

When an instruction for activating a process of docking with docking station 200B is input in a state in which the display dock 102 is open relative to the operation dock 101 (step S11), an image from the video camera 104 is displayed on the display screen of the display dock 102, and an guide frame 105 is displayed on the display screen of the display dock 102 (step 12). The guide frame 105 shows a connector connection position at a position corresponding to the connector 103 on the computer 100 side relative to the sight line of the video camera 104.

In this state, the user moves the whole computer 100 while looking at the display screen in such a way that the connector image 201′ is put within the guide frame 105. The user puts down the computer 100 in such a way that the connector image 201′ is put within the guide frame 105, and the user places the computer 100 on the docking station 200. In this manner, the connector 103 of the computer 100 is connected to the connector 201 of docking station 200B, thereby completing docking. When the computer 100 detects the completion of docking (step S13), the display of the camera image and the guide frame 105 is stopped (step S14), and a series of steps are finished.

The following first to third examples are considered as examples of the above input for instruction for activating a process of docking.

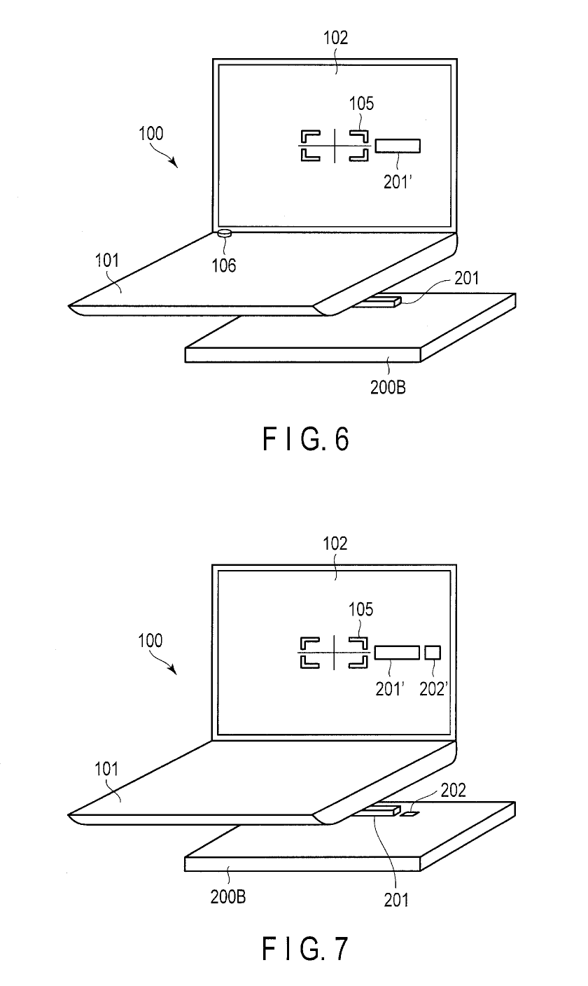

The first example is as follows. As shown in FIG. 6, a dedicated docking process activation key 106 is provided in the operation dock 101. When an instruction is input through the activation key 106 for docking, the screen display for a process of docking is executed. The activation key 106 may be shared by another key.

In the second example, as shown in FIG. 7, an identification mark 202 is marked near the connector 201 on the docking station 200B side. On the computer 100 side, while the computer 100 is moved, the camera 104 is put into operation without display of an image. When the identification mark 202′ is displayed in the camera image, the camera image is displayed on the screen.

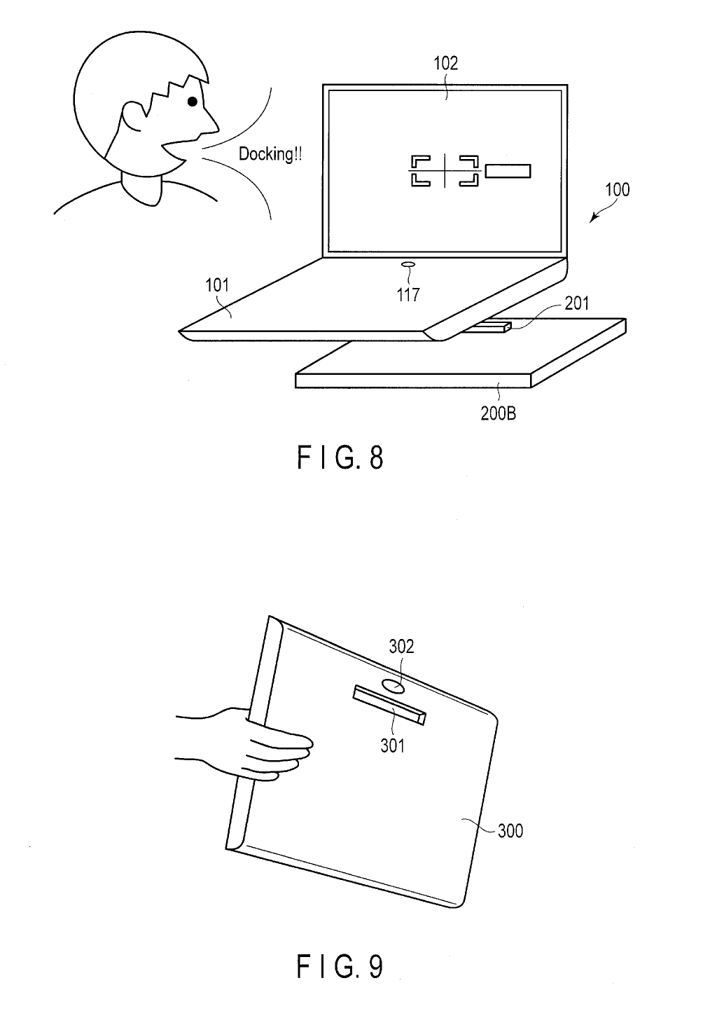

In the third example, as shown in FIG. 8, activation of a process of docking is instructed by saying “docking” toward the microphone 117 of the computer 100 by means of the speech-recognition function provided in the computer 100. In this manner, the screen display for a process of docking is executed.

As described above, according to the structure of the first embodiment, a connector guide screen is displayed when docking activation is started. Therefore, a physical guide mechanism is unnecessary on the docking station side. This structure realizes a versatile docking station. If there is the versatile docking station in the destination of movement, the computer can use the docking station.

A similar structure may be realized in a combination type of tablet computer 300 as shown in FIG. 9. In the combination type of tablet 300, a main body panel and a keyboard panel are integrated. On the under side of the keyboard panel, a connector 301 for connection to a connector on the docking station side is provided. A video camera 302 is provided near the connector 301. Similarly to the above embodiment, display of the connector and a guide frame is executed by camera filming.

Thus, similarly to the above embodiment, if the user merely fits the connector image of the docking station within the guide frame, docking is executable, and the versatile docking station can be used.

### Second Embodiment

A portable computer 100 is required to be sufficiently equipped with an antitheft security function. In the second embodiment, an antitheft security system detecting transfer is realized by using the structure of the first embodiment in which the computer 100 comprises the video camera 104.

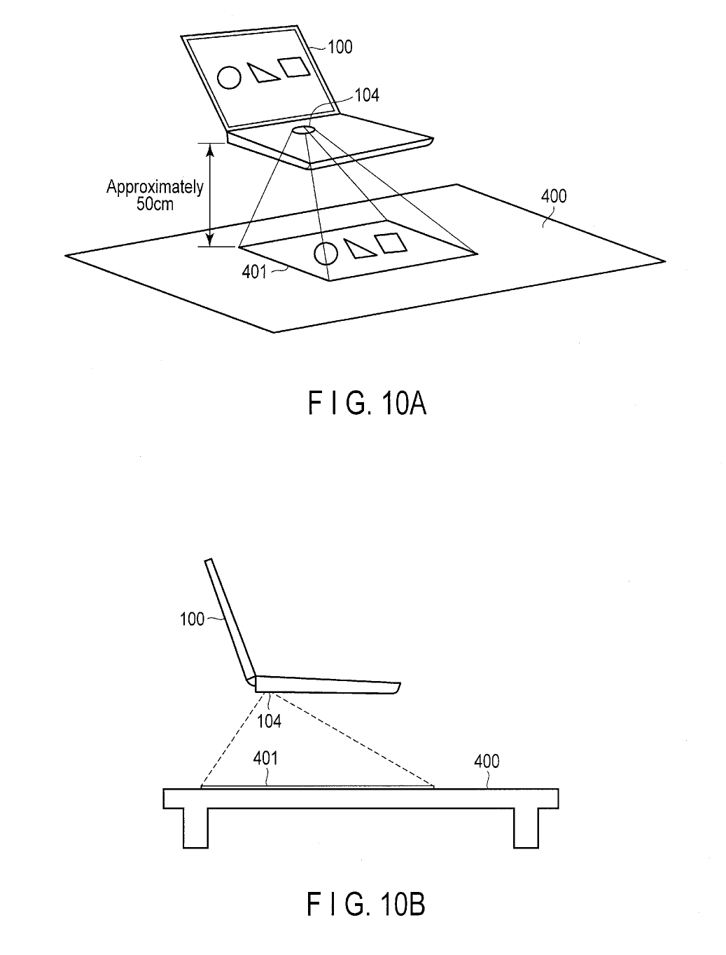

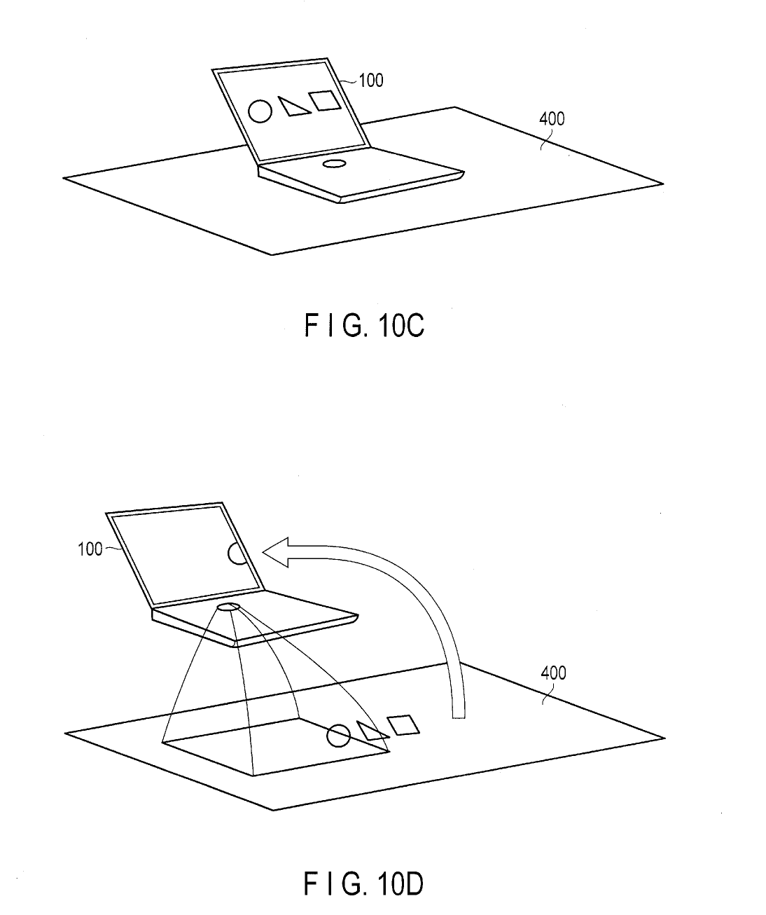

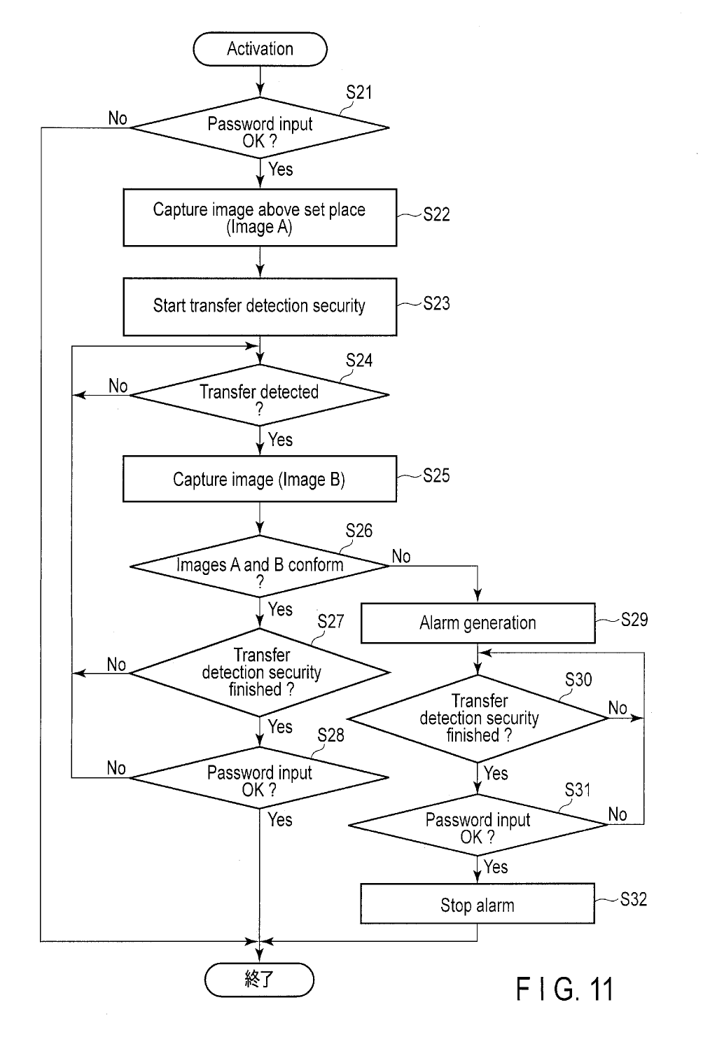

FIG. 10A, FIG. 10B, FIG. 10C and FIG. 10D are shown for explaining the functions of the security system, and suppose that a pattern of ◯ (circle), Δ (triangle) and □ (rectangle) is drawn in line on a desk 400 which is the set place of the computer 100. Hereinafter, the flow of the process of the security system is explained with reference to the flowchart shown in FIG. 11.

First, when the transfer detection security system is activated immediately before placement, an input of the password set in advance is prompted in order to authenticate the user (step S21).

Next, as shown in the perspective illustration of FIG. 10A and the side view of FIG. 10B, when the user captures a still image of the desk 400 at a position above (substantially 50 cm above) the set place by means of the video camera 104 in the computer 100 (step S22), the computer 100 detects and displays the captured still image on the display screen, stores the image as image A and begins monitoring of the transfer detection security (step S23). The computer 100 is placed on the desk 400 as shown in FIG. 10C. At this point, the video camera 104 is put in an imaging state. In the image which is continuously captured by the video camera 104, a part of image A or nothing is shown. The security system determines that this state is placement-in-progress.

When transfer is detected from change in the imaging image of the video camera 104 after monitoring is started (step S24), image B (moving image) captured by the video camera 104 is obtained (step S25). Image B is compared with the stored image A in series in order to determine whether or not the images conform to each other (step S26). If the images are within the range of conformance at this point, an inquiry concerning whether or not the transfer detection security should be finished is made toward the user (step S27). In the case where the security should not be finished, the process goes back to step S23 in order to start monitoring. In the case where the security should be finished, the user is prompted to enter a password (step S28). If the password is correct, a series of steps are finished. If a password is not input, the process goes back to step S23 in order to start monitoring.

On the other hand, in a state in which image B does not conform to image A as shown in FIG. 10D in step S26, an alarm sounds in order to call the user's attention (step S29). Here, whether or not the transfer detection security should be finished is determined (step S30), and the user is prompted to enter a password (step S31). In the case where the above determination of completion of the transfer detection security and the above password authentication are completed, the alarm is stopped (step S32), and a series of steps are finished.

In the security system of this embodiment, in the case where the computer 100 is transferred, it is necessary to enter a password and finish the security monitoring state. If the computer 100 is transferred without normal completion of the security monitoring state, and the conformance rate of images A and B is, for example, substantially 30% or less, the transfer is determined as invalid transfer (theft), and an alarm sounds. If the user unexpectedly moves the computer 100 without finishing the security monitoring state and generates an alarm, the alarm is stopped by entering a password and finishing the security monitoring state.

According to the above structure, it is possible to realize the easy security system using the video camera provided on the bottom surface.

### Another Embodiment

In the explanations of the above embodiments, a desk is supposed as the place in which the computer 100 is put. However, the place may be a pallet of a charger having a contactless charging function. In the case where the computer 100 has a contactless charging function, the computer 100 is placed on the pallet of the contactless charger to be charged. At this time, a portion in which charging can be efficiently conducted is indicated by a mark in the pallet. The computer 100 captures an image of the pallet surface by means of a video camera 104 provided on the bottom surface, and displays the image on the screen. At this time, the mark of the pallet surface is identified and displayed. The user puts down the computer 100 while looking at the mark of the display screen, thereby easily and accurately placing the computer 100 at the marked position.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computer apparatus comprising:
a display dock comprising a display device;
an operation dock comprising a back surface configured to allow for placement of the computer apparatus on an external device;
an imaging device on the back surface of the operation dock, the imaging device configured to capture an image in accordance with an imaging instruction input; and
a display controller configured to display the image captured by the imaging device on the display device of the display dock in accordance with a display instruction input.

2. The computer apparatus according to claim 1, further comprising:
a connector on the back surface of the operation dock, the connector on the back surface configured to connect to a connector of the external device when the computer apparatus is placed; and
a connection instructor configured to instruct a connection of the connector on the back surface and the connector of the external device, wherein
the display controller displays a positioning image corresponding to the connector on the back surface overlaying the image captured by the imaging device in accordance with an instruction for the connection.

3. The computer apparatus according to claim 2, wherein
the connection instructor comprises an operation button for inputting the instruction for the connection, and instructs the connection in accordance with an input operation of the operation button.

4. The computer apparatus according to claim 2, wherein
the connection instruction unit instructs the connection when a specific positioning mark appears in the image captured by the imaging device.

5. The computer apparatus according to claim 2, wherein
the connection instructor is configured to instruct the connection using a speech recognition function in the computer apparatus, when the speech recognition function recognizes a speech corresponding to the connection.

6. The computer apparatus according to claim 1, further comprising
a security manager configured to capture, with the imaging device, an image of a place where the computer apparatus is placed, store the image as a reference image, and execute security management in accordance with an instruction input of a security, wherein
the security manager compares an image captured by the imaging device with the reference image, and generates an alarm when similarity of the images goes beyond an allowable range.

7. The computer apparatus according to claim 6, wherein
the security manager requests a password input in order to stop the security management and the alarm generation.

8. The computer apparatus according to claim 1, further comprising
a charging manager configured to capture an image of a plate of a wireless charger with the imaging device and determine a positioning mark indicating a place for placement from the image, wherein
the display controller displays the image captured by the imaging device on the display device, and the identified positioning mark.

9. A control method of a computer apparatus including a display dock comprising a display device and an operation dock comprising a back surface configured to allow for placement of the computer apparatus on an external device, the method comprising
displaying an image captured by an imaging device on the back surface of the operation dock on the display device of the display dock in accordance with a display instruction input.

10. The control method of the computer apparatus according to claim 9, wherein
overlaying a positioning image corresponding to a connector on the back surface on the image captured by the imaging device in accordance with an instruction for connection of the connector on the back surface and a connector of the external device.

11. The control method of the computer apparatus according to claim 10, wherein
instructing the connection based on an input operation of an operation button.

12. The control method of the computer apparatus according to claim 10, wherein
instructing for the connection based on recognition of a specific positioning mark in the image captured by the imaging device.

13. The control method of the computer apparatus according to claim 10, wherein
instructing for the connection using a speech recognition function in the computer apparatus, when the speech recognition function recognizes a speech corresponding to the connection.

14. The control method of the computer apparatus according to claim 9, wherein
capturing an image of a place where the computer is placed with the imaging device in accordance with an instruction input of a security,
storing the image as a reference image and executing security management,
comparing an image captured with the imaging image with the reference image and generating an alarm when similarity of the images goes beyond an allowable range.

15. The control method of the computer apparatus according to claim 14, wherein
requesting a password input in order to stop the security management and the alarm generation.

16. The control method of the computer apparatus according to claim 9, wherein
capturing an image of a plate of a wireless charger with the imaging device,
determining a positioning mark indicating a place for placement from the image,
displaying the image captured by the imaging device in the display device and the identified position mark.
